(19) United States
(12) Patent Application Publication
(10) Pub. No.: US 2012/0194874 A1
(43) Pub. Date: Aug. 2, 2012

(54) Mobile Print Quality Assurance Mechanism

(76) Inventor: John G. Milanski, Louisville, CO (US)

(21) Appl. No.: 13/018,990

(22) Filed: Feb. 1, 2011

(51) Int. Cl. G06K 9/64; H04N 1/40

(52) U.S. Cl. 358/448; 382/112

(57) ABSTRACT

A method disclosed. The method includes capturing an image of a printed document, retrieving an electronic version of the printed document and comparing the printed document image to the electronic version of the printed document to verify quality of the printed document.

### FIELD OF THE INVENTION

The invention relates to the field of printing systems, and in particular, to quality control of printing systems.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is typically implemented at a print server to manage a print job from job entry and management through the complete printing process. In high speed printing applications it is necessary to check the accuracy of documents that have been printed in order to maximize customer satisfaction. This process is refereed to quality assurance (QA).

QA is typically performed manually by a printer operator implementing a predefined procedure. However, such procedures are unreliable since human error makes it is relatively impossible to consistently check data within printed documents. In other applications machines employing scanning equipment may be implemented. Such machines are also limited because of an inability to check print quality, find holistic problems or apply judgment as to the sufficiency of the print quality (e.g., what print quality is “good enough”). Further, employing machines and dedicated personnel necessary to perform each QA method is expensive.

Accordingly, an efficient QA mechanism is desired.

### SUMMARY

In one embodiment, a method disclosed. The method includes capturing an image of a printed document, retrieving an electronic version of the printed document and comparing the printed document image to the electronic version of the printed document to verify quality of the printed document.

Another embodiment discloses a mobile device including a camera to capture an image of a printed document, a processing unit, a computer-readable medium coupled to the processing unit and a quality assurance (QA) application executed by the processing unit to verify quality of the printed document by analyzing the printed document image.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of a mobile device;

FIG. 3 illustrates one embodiment of a QA tool;

FIG. 4 is a flow diagram illustrating one embodiment of QA process; and

FIG. 5 illustrates one embodiment of a computer system.

### DETAILED DESCRIPTION

A QA mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

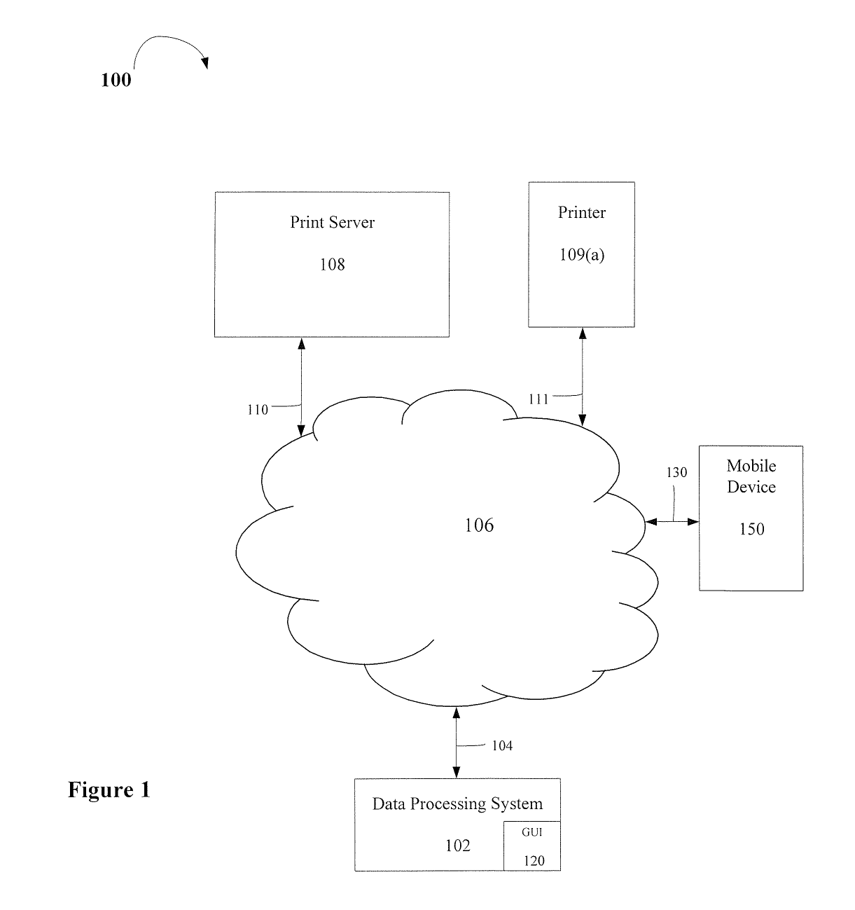

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to a printer 109 for printing, which is coupled to network 106 via communications links 111.

In one embodiment, the operating system on data processing system 102 allows a user to select the desired print server 108 and submit requests for service requests to printer 109 via print server 108 over network 106. Although described as separate entities, other embodiments may include print server 108 being incorporated in one or more of the printers 109.

However in other embodiments, print server 108 and printer 109 may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 between data processing system 102 and printer 109. In other embodiments, the printing software product manages printing of documents from multiple data processing systems 102 to the one or more printers 109.

In a further embodiment, the printing software product may be implemented using either InfoPrint Manager (IPM) or InfoPrint ProcessDirector (IPPD), although other types of printing software may be used instead. In one embodiment, network 100 includes a mobile device 150 coupled to network 106 via a wireless communications link 130. In one embodiment, mobile device 150 is a smart phone. However in other embodiments, mobile device 150 may be implemented as a tablet personal computer.

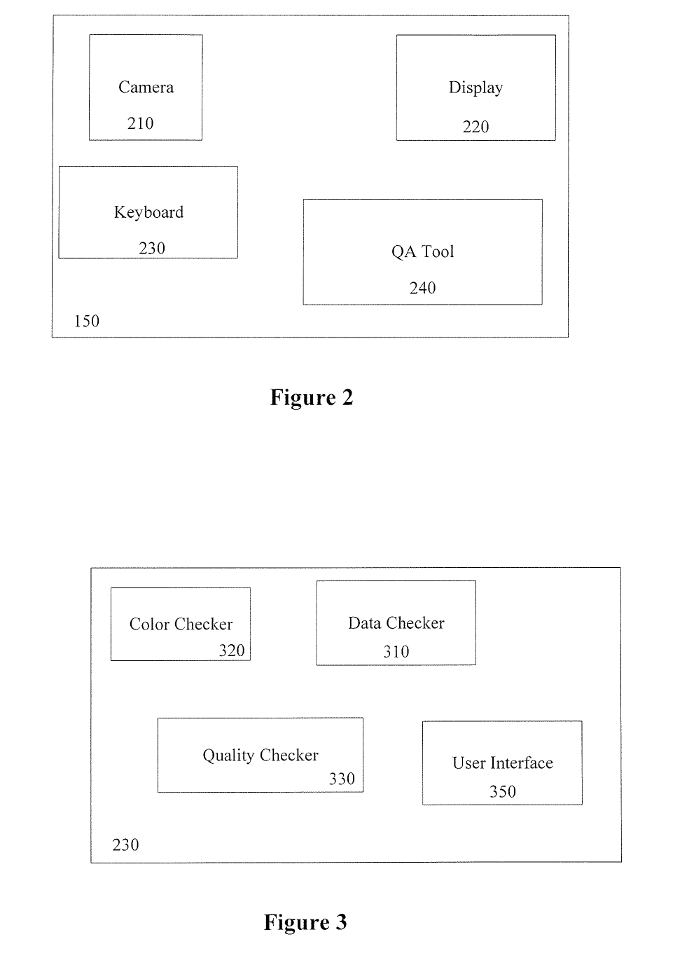

FIG. 2 illustrates one embodiment of a mobile device 150, including a camera 210, a display 220, keyboard 230 and a QA tool 240. In one embodiment, QA tool 240 is an application installed on mobile device 150 that enables an operator, or dedicated QA personnel, to perform spot checks of any document printed at printer 109. In another embodiment, QA Tool 240 may be remotely installed and accessed via a network when needed. In such an embodiment, remote installation would allow a faster, more powerful computer to perform the operations of QA Tool 240.

FIG. 3 illustrates one embodiment of a QA tool 240. As shown in FIG. 3, QA tool 240 includes a data checker 310, a color checker 320 and a quality checker 330. According to one embodiment, data checker 310 enables a check of the quality of data printed on a document produced at printer 109. In one embodiment, data checker 310 checks the data quality using an automated algorithm that compares words between the electronic and physical version of the document. However in other embodiments, the data quality may be checked by an operator.

In one embodiment, machine readable data (e.g., QR code) is included in the margins of the medium (e.g., paper) on which the document is printed in order to identify the correct location in the document. The operator uses camera 210 to read the machine readable data on the document while capturing an image of the document page.

Subsequently, QA tool 240 uses a code embedded in the machine readable data to retrieve an electronic version of the print document. According to one embodiment, data checker 310 acquires an electronic document page by wirelessly transmitting the machine readable data to printing software product at server 108, which in turn uses the data to search a database for the document page corresponding to the machine readable data. Upon retrieval from the database, the document is transmitted from server 108 to mobile device 150 for display at display 220.

In another embodiment, the most recent print jobs may be transmitted to mobile device 150 and stored in a local database, which data checker 310 searches upon reading the machine readable data. Once displayed at display 220, the electronic version of the print document is compared to the printed version. In one embodiment, an operator may compare the printed document with the electronic copy to confirm that the page was printed correctly. In a further embodiment, QA tool 240 implements optical character recognition (OCR) to compare text acquired from an image of the printed document with text in the electronic version. In either embodiment the operator may confirm differences as acceptable, or unacceptable, and then forward results for approval by a supervisor or formal QA expert.

In yet another embodiment, the operator may search the electronic copy of the document for the correct page if the wrong page has been printed. In such an embodiment, data checker 310 enables a portion of a electronic page being displayed to move correspondingly to the section of the page at which camera 210 is receiving image data. In such an embodiment, the machine readable data indicates the location of the machine readable code with reference to the document page. Thus, as an operator moves camera 210 along a printed document page to the part of the page the electronic version of the page is displayed accordingly.

Color checker 320 is implemented to compare printed color values with the designed color values (e.g., values that were intended to be printed). In one embodiment, the operator uses camera 210 to acquire an image of a printed color, along with a standard color bar (e.g., printed on either the page or a nearby master) for reference. In response, color checker 320 converts the image to print color values and compares the print color values to the color values of the corresponding section of the displayed electronic document.

In one embodiment, color checker 320 provides an indication that the color difference between printed color values and the displayed color values exceeds a predetermined threshold. In such an embodiment, the threshold may be changed in real-time using a slider bar in a user interface (UI) 350 component of QA Tool 240. If the color difference exceeds the predetermined threshold the, color checker 320 may transmit the related data (e.g., color values, images, etc.) to the printing software product, or data processing system 102, for supervisory review.

In one embodiment, UI 350 indicates areas of difference using a highlight mask over areas of the image that exceed the threshold. In a further embodiment, the data may be saved at mobile device 150 for later diagnoses. In yet another embodiment, color checker 320 may be implemented to calibrate QA tool 340 by taking a picture of a color bar on a printed page.

Quality checker 330 is implemented to check for overall quality problems for a printed document. In one embodiment, an image of an entire printed page is captured. Quality checker 330 subsequently overlays the captured image on the electronic version of the print data (e.g., using the machine readable code as a reference point) and highlights areas that do not overlap. In a further embodiment, the captured image may be uploaded to the printing software product for comparison with the electronic print data. In yet a further embodiment, the captured image and the electronic print data may be uploaded to a website where a customer may login and verify print quality.

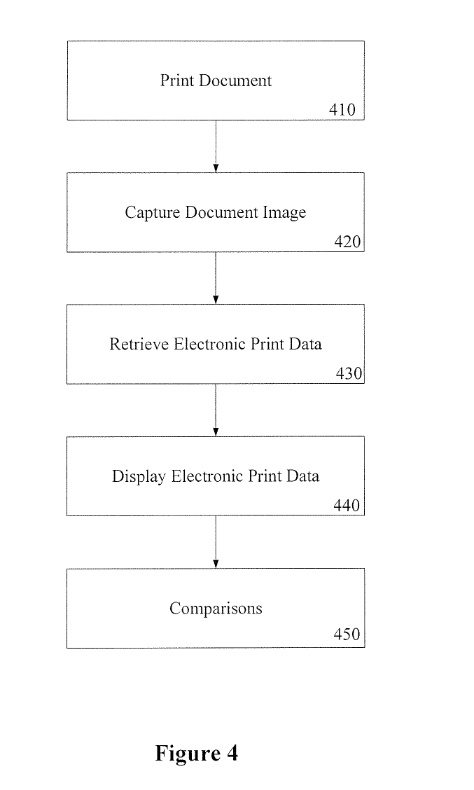

FIG. 4 is a flow diagram illustrating one embodiment of process performed by QA tool 240. At processing block 410, a document is printed. At processing block 420, the printed document, including the machine readable code, is read by camera 210. At processing block 430, an electronic version of the print document associated with the machine readable code is retrieved. At processing block 440, the electronic version of the print document is displayed at mobile device 150. At processing block 450, comparisons implemented at data checker 310, color checker 320 and a quality checker 330 are performed as discussed above.

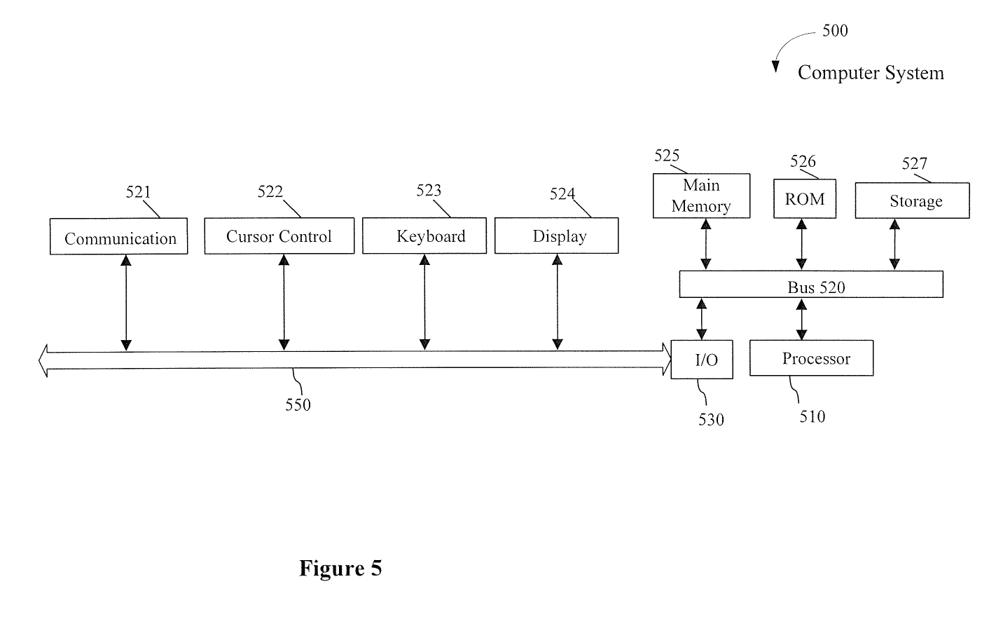

FIG. 5 illustrates a computer system 500 on which mobile device 150, data processing system 102 and/or server 108 may be implemented. Computer system 500 includes a system bus 520 for communicating information, and a processor 510 coupled to bus 420 for processing information.

Computer system 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Computer system 500 also may include a read only memory (ROM) and or other static storage device 526 coupled to bus 520 for storing static information and instructions used by processor 510.

A data storage device 525 such as a magnetic disk or optical disc and its corresponding drive may also be coupled to computer system 500 for storing information and instructions. Computer system 500 can also be coupled to a second I/O bus 550 via an I/O interface 530. A plurality of I/O devices may be coupled to I/O bus 550, including a display device 524, an input device (e.g., an alphanumeric input device 523 and or a cursor control device 522). The communication device 521 is for accessing other computers (servers or clients). The communication device 521 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A mobile device comprising:
a camera to capture an image of a printed document;
a processing unit;
a computer-readable medium coupled to the processing unit; and
a quality assurance (QA) application executed by the processing unit to verify quality of the printed document by analyzing the printed document image.

2. The mobile device of claim 1 wherein the QA application is stored on the computer-readable medium.

3. The mobile device of claim 1 wherein the QA application is stored at a remote networked location.

4. The mobile device of claim 1 wherein the camera reads a machine readable label on the printed document and the QA application uses a code embedded in the machine readable label to retrieve an electronic version of the printed document.

5. The mobile device of claim 4 wherein the machine readable label is a QR code.

6. The mobile device of claim 4 wherein the QA application wirelessly retrieves the electronic version of the printed document from a print server.

7. The mobile device of claim 4 wherein the QA application comprises:
a data checker to verify accuracy of text data included in the printed document image;
a color checker to verify accuracy of color objects in the printed document image; and
a quality checker to detect quality problems in the printed document image.

8. The mobile device of claim 7 wherein the data checker compares the printed document image to the electronic version of the printed document to detect differences in text data.

9. The mobile device of claim 7 wherein the color checker converts color values acquired from a section of the printed document image to color values and compares the values to desired color values for the section of the printed document image.

10. The mobile device of claim 9 wherein color checker provides an indication that the difference between the printed document image color values and the desired color values for the section of the printed document image are greater than a predetermined threshold.

11. The mobile device of claim 7 wherein the quality checker overlays the printed document image over the electronic version of the printed document.

12. The mobile device of claim 11 wherein the quality checker highlights areas of the printed document image that do not overlap the electronic version of the printed document.

13. A computer generated method comprising:
capturing an image of a printed document;
retrieving an electronic version of the printed document; and
comparing the printed document image to the electronic version of the printed document to verify quality of the printed document.

14. The method of claim 13 wherein capturing the printed document image comprises reading a machine readable label located on the printed document.

15. The method of claim 14 wherein retrieving the electronic version of the printed document comprises using a code embedded in the machine readable label to retrieve the electronic version of the printed document.

16. The method of claim 13 wherein comparing the printed document image to the electronic version of the printed document comprises detecting differences in text data.

17. The method of claim 16 wherein comparing the printed document image to the electronic version of the printed document further comprises comparing color values acquired from a section of the printed document image to desired color values for the section.

18. The method of claim 17 wherein comparing the printed document image to the electronic version of the printed document further comprises:
overlaying the printed document image over the electronic version of the printed document; and
highlighting areas of the printed document image that do not overlap the electronic version of the printed document.

19. An article of manufacture comprising a machine-readable medium including data that, when accessed by a machine, cause the machine to perform operations comprising:
capturing an image of a printed document;
retrieving an electronic version of the printed document; and
comparing the printed document image to the electronic version of the printed document to verify quality of the printed document.

20. The article of manufacture of claim 19 wherein comparing the printed document image to the electronic version of the printed document comprises detecting differences in text data.
